(19) United States
(12) Patent Application Publication
(10) Pub. No.: US 2014/0020995 A1
(43) Pub. Date: Jan. 23, 2014

(54) Annular Dashpot Damper

(71) Applicants: Mark Leonard Hopper, West Chester, OH (US); Joshua Dean Smith, Cincinnati, OH (US)

(72) Inventors: Mark Leonard Hopper, West Chester, OH (US); Joshua Dean Smith, Cincinnati, OH (US)

(21) Appl. No.: 13/552,269

(22) Filed: Jul. 18, 2012

(51) Int. Cl. F16F 9/14; F16F 15/16

(52) U.S. Cl. CPC F16F 9/14; F16F 15/161
USPC 188/297

(57) ABSTRACT

An annular dashpot damper is utilized to provide flow resistance from viscous shear to an orifice or gap which provides flow metering. This is accomplished by dividing the flow channel into circumferential segments or damping cavities which are sealed and limit rotational flow of the fluid.

### BACKGROUND

Present embodiments relate generally to structures having rotating shafts. More specifically the present embodiments relate to an annular dashpot damper for structures having rotating shafts, for example gas turbine engines, which dampen radial movement of a shaft during operation.

In a gas turbine engine for example, air is pressurized in a compressor and mixed with fuel in a combustor for generating hot combustion gases which flow downstream through turbine stages. These turbine stages extract energy from the combustion gases. A high pressure turbine first receives the hot combustion gases from the combustor and includes a stator nozzle assembly directing the combustion gases downstream through a row of high pressure turbine rotor blades extending radially outwardly from a supporting rotor disk. In a two stage turbine, a second stage stator nozzle assembly is positioned downstream of the first stage blades followed in turn by a row of second stage rotor blades extending radially outwardly from a second supporting rotor disk. This results in conversion of combustion gas energy to mechanical energy.

The first and second rotor disks are coupled to the compressor by a corresponding high pressure rotor shaft for powering the compressor during operation. A multi-stage low pressure turbine may or may not follow the multi-stage high pressure turbine and may be coupled by a second shaft to a fan disposed upstream from the compressor.

As the combustion gas flows downstream through the turbine stages, energy is extracted therefrom and the pressure of the combustion gas is reduced. The combustion gas may continue through multiple low stage turbines.

The annular nozzle assembly is formed of a plurality of nozzle segments which are joined at circumferential ends of the segments. Each high pressure turbine nozzle includes vanes which are hollow and receive a portion of pressurized cooling air from the compressor to cool the vanes during operation. A portion of the vane air is then channeled radially inwardly from a radially outer band or wall through the vane to the inner band or wall.

In current gas turbine engines, shaft dynamics are controlled by oil filled squeeze film dampers wherein a thin film of oil is positioned between two concentric non-rotating cylinders or rings. The outer ring is stationary and the inner ring is allowed to orbit but does not rotate. Oil flows around the cylinders due to the pumping motion created by movement of the shaft and the inner orbiting ring. The shear of the fluid along with the inertial forces provide damping to resist motion of the inner rings. The desired damping is achieved by adjusting the flow channel gap between an orbiting ring which may be mounted to a shaft bearing and a stationary ring mounted to the engine frame or static structure. The term orbit, or orbiting, as used herein means non-rotating but movable in a radial direction with the shaft. In many cases the gap required to achieve the desired damping may be very small which may overly restrict shaft deflection and create high pressure gradients. In order for this construction to operate properly, the gap between the inner and outer ring that form the flow channel must be very thin. This creates a high potential for the damper to bottom out. Additionally, the gap may generate heat due to the viscous shear in the fluid during the damping reaction.

It would be desirable to reduce or eliminate these and other deficiencies while providing proper damping for a turbine engine shaft which may move radially due to dynamic loads which occur during operation.

### SUMMARY

An annular dashpot damper is utilized to provide flow resistance from viscous shear to an orifice or gap which provides flow metering. This is accomplished by dividing the flow channel into circumferential segments or damping cavities which are sealed and limit rotational flow of the fluid.

According to some embodiments, an annular damper for a rotating shaft, comprises a first ring which orbits with the engine shaft, the first ring having a plurality of dividers extending radially between the first ring and a second ring and spaced circumferentially, the first ring capable of moving radially with the shaft, the second ring disposed radially outward of the first ring, a plurality of damping cavities defined between the first ring, the second ring and the dividers, the plurality of damping cavities having a damping fluid, wherein the damping fluid damps movement of the first ring and the shaft.

All of the above outlined features are to be understood as exemplary only and many more features and objectives of the annular dashpot damper may be gleaned from the disclosure herein. Therefore, no limiting interpretation of this summary is to be understood without further reading of the entire specification, claims, and drawings included herewith.

### BRIEF DESCRIPTION OF THE ILLUSTRATIONS

The above-mentioned and other features and advantages of these exemplary embodiments, and the manner of attaining them, will become more apparent and the annular dashpot damper feature will be better understood by reference to the following description of embodiments taken in conjunction with the accompanying drawings, wherein:

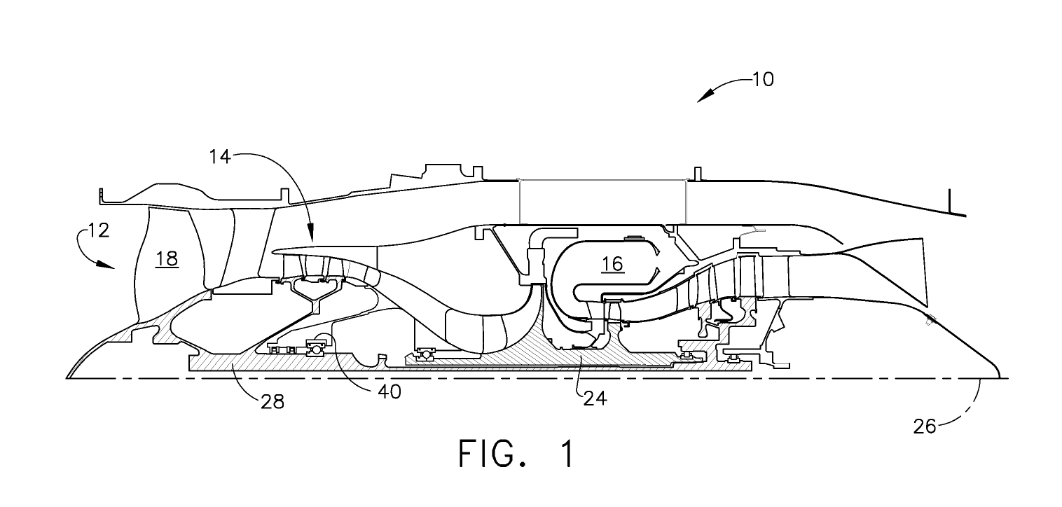

FIG. 1 is a side section view of an exemplary gas turbine engine.

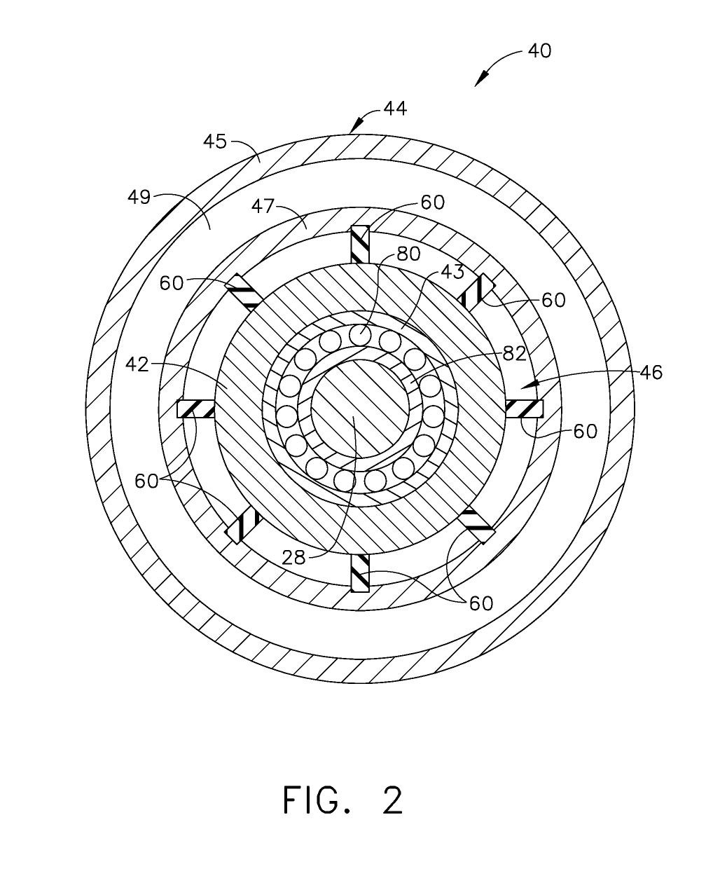

FIG. 2 is a schematic sectional view of an exemplary annular dashpot damper assembly.

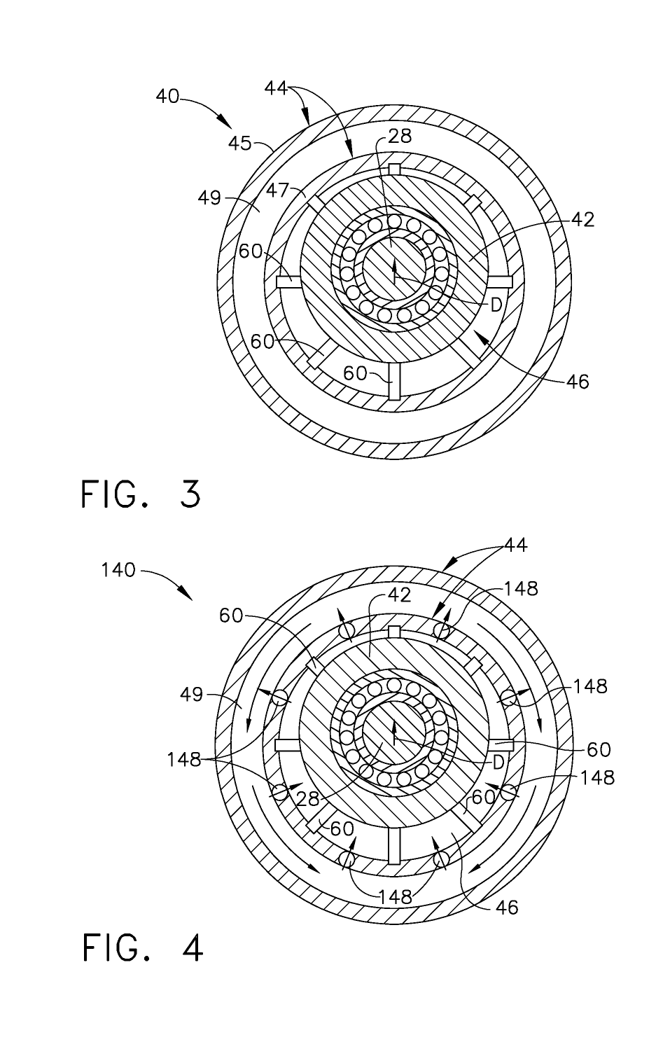

FIG. 3 is a schematic section view of the embodiment of FIG. 2 with the shaft shifted within the damper assembly.

FIG. 4 is a schematic section view of an alternate embodiment of an annular dashpot damper assembly including the flow orifices in a stationary ring.

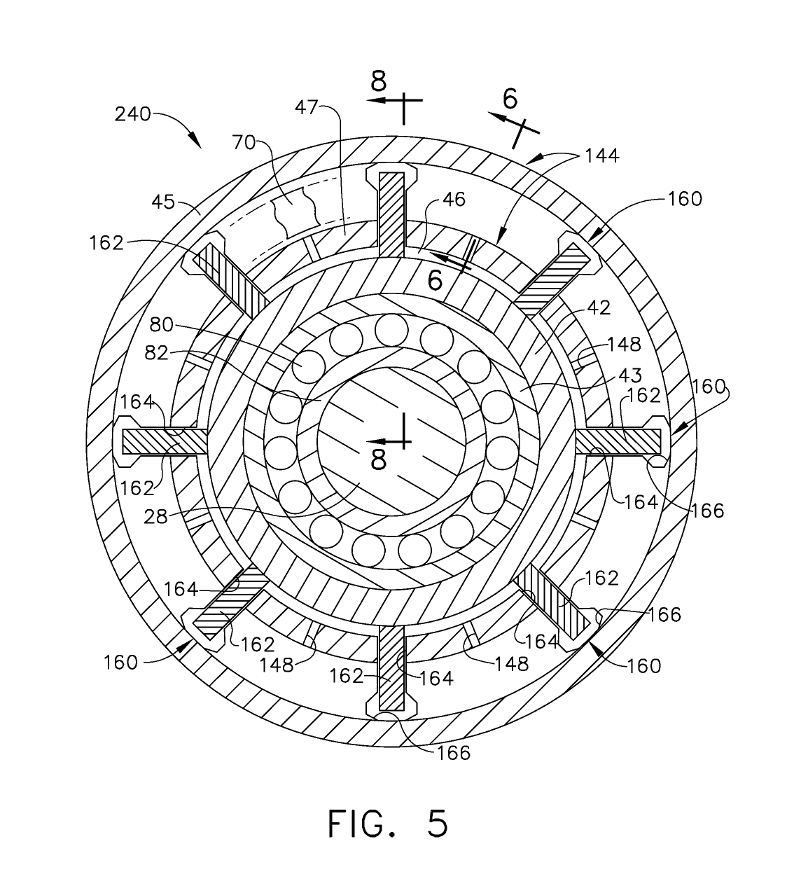

FIG. 5 is a schematic view of an exemplary dashpot damper assembly.

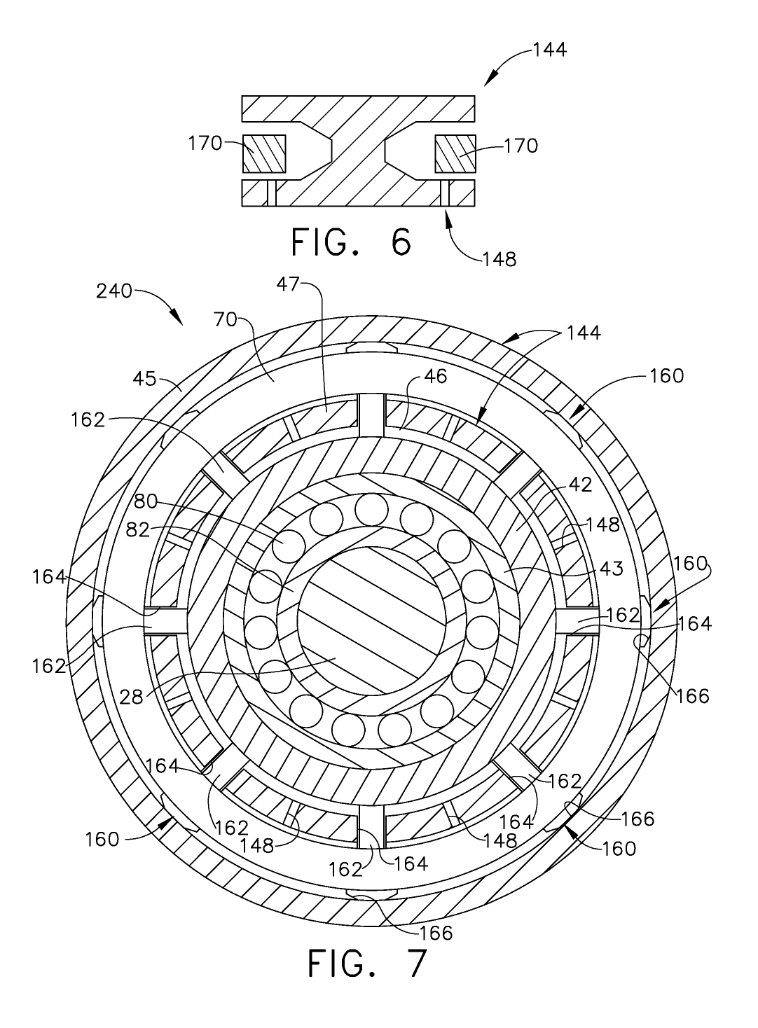

FIG. 6 is a section view of a portion of a stationary ring of the damper assembly.

FIG. 7 is an alternative section view of the embodiment of FIG. 5.

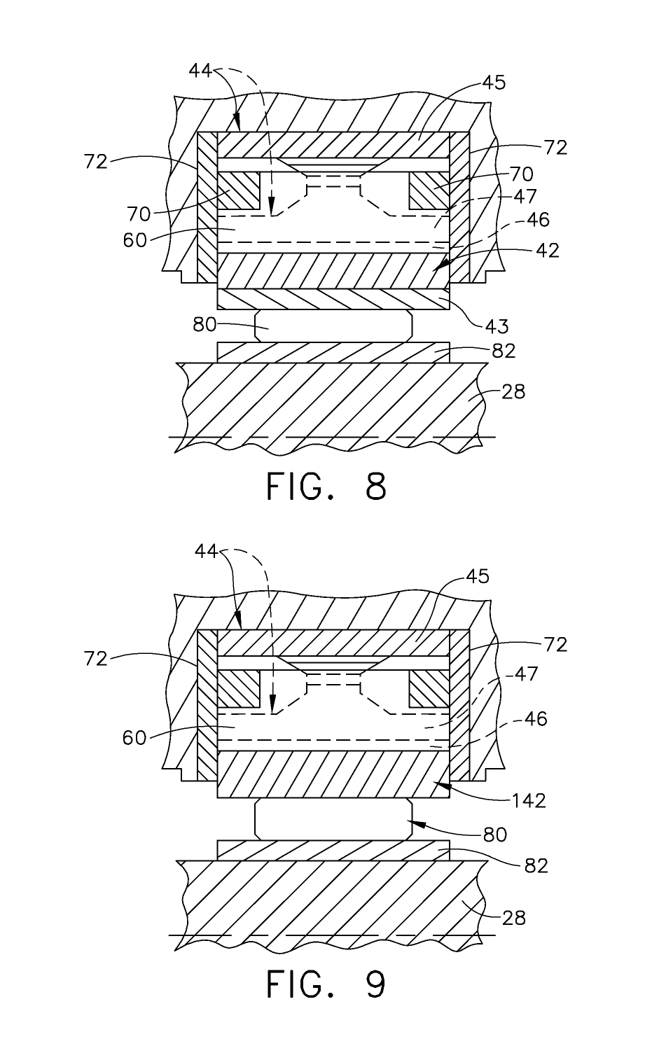

FIG. 8 is an alternate embodiment of the dashpot damper.

FIG. 9 is a further alternative embodiment utilizing an integral outer bearing race.

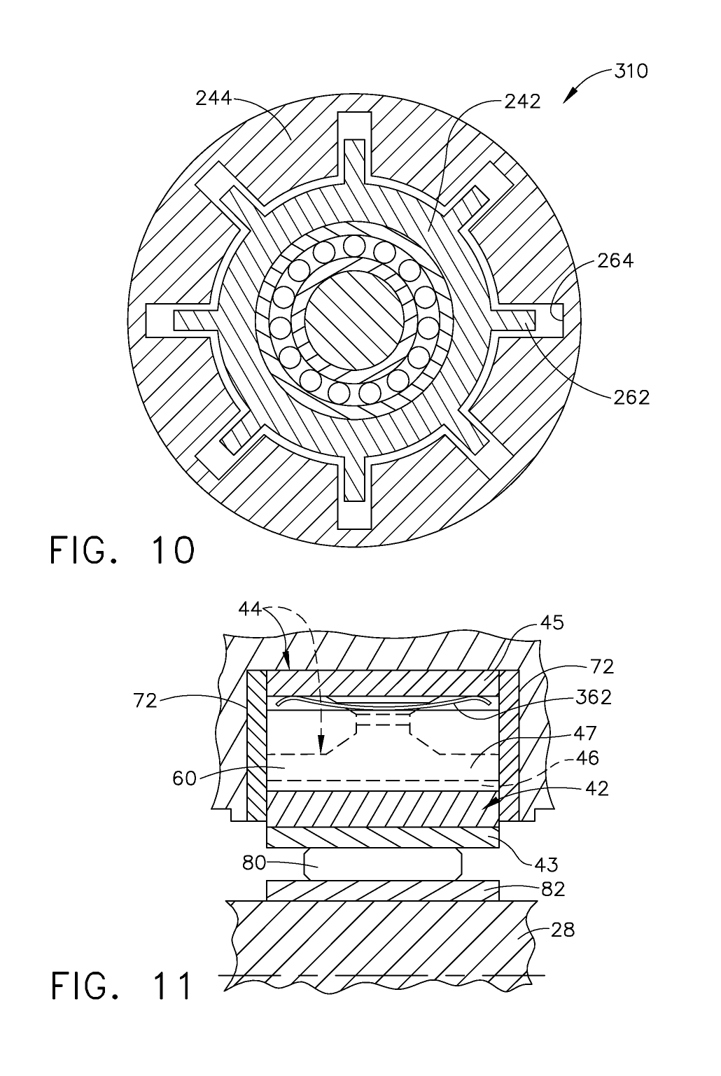

FIG. 10 is an embodiment of a dashpot damper assembly with integral dividers formed on the inner ring of the assembly.

FIG. 11 is a further embodiment of FIG. 8 including a biasing spring.

### DETAILED DESCRIPTION

Reference now will be made in detail to embodiments provided, one or more examples of which are illustrated in the drawings. Each example is provided by way of explanation, not limitation of the disclosed embodiments. In fact, it will be apparent to those skilled in the art that various modifications and variations can be made in the present embodiments without departing from the scope or spirit of the disclosure. For instance, features illustrated or described as part of one embodiment can be used with another embodiment to still yield further embodiments. Thus it is intended that the present invention covers such modifications and variations as come within the scope of the appended claims and their equivalents.

Referring to FIGS. 1-11, various embodiments of a gas turbine engine are depicted having an annular dashpot damper. The damper assembly includes a plurality of dividers which form multiple damping cavities wherein a damping fluid is disposed. An inner ring is connected either directly or indirectly to an engine shaft and an outer ring is disposed radially outward of the inner ring defining the damping cavities therebetween. The dividers may be formed of one or more pieces allowing movement of the inner ring and shaft in radial directions. Additionally, the assembly may include apertures to allow movement of oil therethrough to further dampen shaft orbital movement. While a gas turbine engine is used as an example in the present disclosure, one skilled in the art should realize that the annular dashpot damper may be utilized in various structures utilizing rotating or vibrating shafts other than gas turbines. For example, the annular dashpot damper may be utilized to stabilize or damp vibration in a helicopter drive shaft. Other uses are well within the scope of this disclosure.

The terms fore and aft are used with respect to the engine axis and generally mean toward the front of the turbine engine or the rear of the turbine engine in the direction of the engine axis, respectively. The term radially is used generally to indicate a direction perpendicular to an engine axis.

Referring initially to FIG. 1, a schematic side section view of a gas turbine engine 10 is shown having an engine inlet end 12, a compressor 14, a combustor 16 and a multi-stage high pressure turbine 20. The gas turbine 10 may be used for aviation, power generation, industrial, marine or the like. Depending on the usage, the engine inlet end 12 may alternatively contain multi-stage compressors rather than a fan. The gas turbine 10 is axis-symmetrical about engine axis 26 or shaft 24 so that various engine components rotate thereabout. In operation air enters through the air inlet end 12 of the engine 10 and moves through at least one stage of compression where the air pressure is increased and directed to the combustor 16. The compressed air is mixed with fuel and burned providing the hot combustion gas which exits the combustor 16 toward the high pressure turbine 20. At the high pressure turbine 20, energy is extracted from the hot combustion gas causing rotation of turbine blades which in turn cause rotation of the shaft 24. The shaft 24 passes toward the front of the engine to continue rotation of the one or more compressor stages 14, a turbofan 18 or inlet fan blades, depending on the turbine design.

The axis-symmetrical shaft 24 extends through the through the turbine engine 10, from the forward end to an aft end. The shaft 24 is supported by bearings along its length. The shaft 24 may be hollow to allow rotation of a low pressure turbine shaft 28 therein. Both shafts 24, 28 may rotate about the centerline 26 of the engine. During operation the shafts 24, 28 rotate along with other structures connected to the shafts such as the rotor assemblies of the turbine 20 and compressor 14 in order to create power or thrust depending on the area of use, for example power, industrial or aviation.

Referring still to FIG. 1, the inlet 12 includes a turbofan 18 which has a plurality of blades. The turbofan 18 is connected by shaft 28 to the low pressure turbine 19 and creates thrust for the turbine engine 10. The low pressure air may be used to aid in cooling components of the engine as well.

A damper assembly 40 is shown in the area of the low pressure shaft 28 for point of reference. The damper assembly 40 dampens radial motion of the shaft 28 which occurs due to dynamic loads incurred at the shaft during rotation. However, one skilled in the art should realize that the damper assembly 40 may alternatively be utilized at various other positions along the low pressure shaft or also along various points of the high pressure shaft 24.

Referring now to FIG. 2, a schematic side section view of an exemplary annular dashpot damper assembly 40 is depicted. The exemplary damper assembly 40 includes an inner ring 42 which is connected to a rotating shaft of a turbine engine 10. The ring 42 may be defined by an outer bearing race or may be a ring structure as depicted which receives an outer bearing race 43. In the embodiment depicted, a bearing assembly includes the outer race 43, an inner race 82 and a plurality of ball bearings or roller bearings 80. In the embodiment, the inner race 82 is mounted on the shaft 28. Whether or not the ring 42 is connected to the bearing race 43 or is integrally formed with the race 43, the ring 42 orbits with the engine shaft 28 so that it moves in radial directions with the shaft 28 during dynamic loading of the shaft. However, the ring 42 does not rotate but is instead fixed so that the shaft 28 and inner race 82 may rotate.

Disposed radially outwardly of the ring 42 is a stationary ring 44. The second ring 44 is spaced from the first ring 10 and provides a damping cavity 46 therebetween. Defining the multiple damping cavities 46 between the first ring 42 and the second ring 44, are a plurality of flow dividers 60. These dividers 60 allow movement of the first ring 42 relative to the second ring 44 but may inhibit bottoming out of the ring 42 against the second ring 44. The dividers 60 may be formed of elastomeric or flexible material or may be formed of two or more elements which move relative to one another. Pressure generated within the damping cavities 46 will dampen dynamic loading on the shaft limiting the ring 42 movement relative to the second ring 44. The dividers 60 according to one embodiment are seated within the inner component and may be formed to allow orbiting movement of the first ring 42. The dividers 60 may be formed of a multitude of structures including but not limited to blades, elastomeric, Z-seals, C-seals and the like.

The movement of first ring 42 is in the radial direction but is not rotational. The movement of the dividers 60 through and around oil provide a damping force and may be a plurality of structures which will be described further herein. The damping occurs by generation of pressure on the damping fluid, for example oil, within the cavities 46.

The dividers 60 also provide a second function which is to seal the various compartments from one another and therefore limit the rotational fluid of oil flow in the damping cavity 46. Thus, instead of one large cavity 46 surrounding the ring 10, a plurality of smaller cavities 46 are created wherein fluid is more readily controlled. By creating smaller cavities 46, the cavities allow for better control of the damping fluid by way of orifices, clearances, allowances, or other flow metering structures along or around the dividers 60 or spaced away from the dividers 60. This creates more independently manageable pressure gradients for improved damping of a shaft. Moreover, such structure may be tuned to desirable damping characteristics.

Although not clearly shown in FIG. 2, the second stationary ring 44 is really formed of two rings 44 wherein an inner component 47 is connected to an outer component 45 and joined therebetween by a wall 49, such that the inner and outer components are concentric. With brief reference to FIG. 6, the second stationary ring 44 is generally H-shaped when shown in section perpendicular to the section view of FIG. 2. Other shapes may be utilized, for example, a T-shaped stationary ring 44 may be used, or a one piece and/or solid ring for example.

Referring now to FIG. 3, a schematic side section view of the annular dashpot damper assembly 40 is depicted wherein the ring 42 is shifted due to the dynamic loading on the shaft 28 upward towards a twelve o′clock position, for example. The dynamic loading is represented by an arrow D. As shown, the first ring 42 is closer to the second ring at the top dead center position which results in less volume for the damping cavities 46 near the top of the ring 42. Additionally, the lower cavities 46 near the bottom of the ring 42 have increased volume due to movement of the ring 42. Additionally, as shown by comparing the upper dividers 60 to the lower dividers 60, the upper dividers are of decreased length due to movement of the ring 42 upwardly and the lower dividers 60 are of increased length. In the embodiment of FIGS. 3 and 4, oil in the cavities 46 moves between sliding surfaces of the dividers 60. The dividers 60 may be formed in various manners described further herein.

Referring now to FIG. 4, an alternate embodiment of the annular dashpot damper assembly 140 is depicted schematic section. The assembly 140 includes a plurality of flow orifices 148 in the second ring 44, specifically the inner component 47. This allows oil to flow from each of the damping cavities 46 to an outer volume formed in part by wall 49 and back in during pumping or suction of the oil. As depicted in FIG. 4, the first ring 42 is again depicted in a dynamically loaded position upwardly, for example relative to the second ring 44. The damping may be adjusted by varying the sizing of the flow orifices 148 in the second ring 14. Depending on the direction of movement of the first ring 12, the oil is pumped through the orifices 148 for example at the upper half of the second ring 144. This causes suction in the flow apertures 148 in the lower half of the second ring 144. This movement of oil will vary with the movement of the first ring 12 and the gas turbine engine shaft 28. The orifices 148 may be formed of various structures including controlled end gaps, traditional orifice hole, slots or notches. In additional embodiments, the orifices 148 may be formed through the dividers 60, such as through axial end surfaces or along inner or outer surfaces.

Referring now to FIG. 5, one embodiment of the dividers 60 is depicted. With reference first to the generally depicted structure, the damper assembly 240 includes an inner ring 42 disposed on an outer race 43 of a bearing assembly including a plurality of balls or rollers 80 and an inner race 82 disposed on the shaft 28. The stationary ring 144 may include a plurality of orifices 148 for metering oil therethrough. Between the stationary ring 144 and the inner ring 142 are a plurality of damping cavities 46. Extending between the first inner ring 142 and the second stationary ring 144 are a plurality of dividers 160 defining circumferential segments of the damping cavities 46. The dividers 160 are formed of a vane or blade 162 which slides within a guide 164. The vane or blade 162 may be connected to the first ring 42. Alternatively, the blade or vane 162 may be formed integrally with the first ring 42. The guide 164, which receives the blade 162, is formed with the second ring 144 according to some embodiments. Alternatively, the guides 164 may be connected to the ring 144 by press-fitting for example.

Also shown at radially outward ends of the guides 164 are heads or stress reliefs 166. These optionally may be formed with the guides 164 to retain the guides 164 in position within the damper assembly 240. The stress reliefs 166 also allow damping fluid to flow to both sides of the stationary ring 144.

Also shown in FIG. 5 is a portion of a vane retention ring 70 which extends generally circumferentially about the assembly 240 and between the components 45, 47 of the vane retention ring 70. The vane retention ring 70 is also used, according to the instant embodiment, to retain the vane or blade 162. Referring briefly to FIG. 8, the vane retention rings 70 are placed on both axial sides of an exemplary damper assembly, for example assembly 240 (FIG. 8). The retention ring 70 may also provide a force to push the blades 162 toward the inner ring 142. The retention ring may be formed through various embodiments including, but not limited to, nested rings, solid rings, C-rings or other structures which may be used to provide the force desired.

Referring briefly to FIG. 6, a section view of one exemplary embodiment of the stationary ring 144 is depicted. The depicted embodiment shows the orifices 148 as well as the vane retention ring 170 on one side of the ring 144, for purpose of understanding with comparison to FIG. 5. The vane retention ring 170 may also, but not necessarily, limit radial travel of the divider 60, 160.

Referring now to FIG. 7, the embodiment of FIG. 5 is depicted with the section line moved. In the embodiment shown, the damper assembly 240 more clearly shows the vane retention ring 70.

Referring now to FIGS. 8 and 9, two embodiments of the damper assembly are shown for ease of comparison. Referring first to FIG. 8, one embodiment is depicted wherein the bearing outer race 43 is received by the first ring 42. This may be constructed by press-fitting for example. According to the embodiment of FIG. 5, the first ring 42 receives an outer bearing race 43 such as by press fitting, for example. The outer bearing race 43 is a part of a bearing assembly including, according to the exemplary embodiment, a bearing roller 80 and a bearing inner race 82 which engages a rotating shaft 28. Above the first ring 42 is a damping cavity 46 and the divider 60 which moves with the first ring 43 relative to the second ring 44. End caps 72 may be positioned at axial ends of the assembly to inhibit leakage of damping fluid from the damping cavities 46.

By comparison, and with reference now to FIG. 9, the first ring 142 is integrated with the outer bearing race meaning that the first ring is the outer bearing race or is formed integrally therewith.

Referring to FIG. 10, an additional embodiment of a damping assembly 310 is shown wherein the dividers are formed in the manner previously described. Extending from the first ring 242 and integrally formed therewith are a plurality of blades or vanes 262. Formed integrally in the second ring 244 are a plurality of guides 264. According to either of these embodiments, additional orifices such as orifices 148 in FIG. 4 may also be utilized.

Referring now to FIG. 11, an additional embodiment is depicted. According to the instant embodiment, the structure is similar to the embodiments of FIG. 8. However, in this embodiment of a dashpot damper assembly, a biasing spring 363 is disposed against outer component 45 and biasing the divider 60 toward the orbiting inner ring 42. Various types of biasing springs 362 may be utilized including, but not limited to, leaf, band, coil or elastomeric springs. Also, one skilled in the art should realize that various types of biasing springs may be utilized with various of the other embodiments described herein. Further, the biasing springs 362 may be utilized in addition to or in substitution of the vane retaining rings 70, 170 in FIGS. 5-8.

While multiple inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Examples are used to disclose the embodiments, including the best mode, and also to enable any person skilled in the art to practice the apparatus and/or method, including making and using any devices or systems and performing any incorporated methods. These examples are not intended to be exhaustive or to limit the disclosure to the precise steps and/or forms disclosed, and many modifications and variations are possible in light of the above teaching. Features described herein may be combined in any combination. Steps of a method described herein may be performed in any sequence that is physically possible.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An annular damper for a rotating shaft, comprising:
a first engaged by a plurality of dividers spaced circumferentially;
said first ring capable of moving radially with said shaft;
a second ring disposed radially outward of said first ring, said second ring receiving said plurality of dividers which extend toward said first ring;
a plurality of damping cavities defined between said first ring, said second ring and said dividers, said plurality of damping cavities having a damping fluid;
a metering structure that controls flow of said damping fluid to and from said plurality of damping cavities;
wherein said damping fluid to damps radial movement of said first ring and said shaft.

2. The annular damper of claim 1 wherein said first ring receives an outer bearing race.

3. The annular damper of claim 1, wherein said first ring is an outer bearing race.

4. The annular damper of claim 3, said bearing assembly comprising an outer race connected to said annular damper.

5. The annular damper of claim 1 further wherein said metering structure is an orifice disposed either between said plurality of dividers or through said plurality of dividers.

6. The annular damper of claim 1 wherein damping is adjustable by varying the flow through said metering structure.

7. The annular damper of claim 1 wherein a pressure gradient is created and acts upon said first ring to damp said radial movement of said rotating shaft.

8. The annular damper of claim 1 further wherein said dividers formed integrally with one of said first ring and said second ring.

9. An annular damper assembly for a rotating shaft, comprising:
a first ring disposed radially closer to said shaft;
a second ring disposed radially outwardly from said shaft, said second ring having a plurality of orifices;
a plurality of dividers disposed between said first ring and said second ring allowing movement of said first ring relative to said second ring;
a plurality of damping cavities disposed between said first ring and said second ring wherein damping fluid is pumped to and pumped from said plurality of damping cavities through said plurality of orifices;
wherein movement of said first ring is damped by pressure gradient created in said plurality of damping cavities.

10. The annular damper of claim 9 further comprising a seal on said damping segment to allow axial movement of said shaft.

11. The annular damper of claim 9 wherein said plurality of dividers spaced circumferentially between said first ring and said second ring.

12. The annular dashpot damper of claim 9, said plurality of dividers being sliding vane dividers.

13. The annular dashpot of claim 9, said plurality of dividers being elastomeric dividers.

14. The annular dashpot damper of claim 9, said plurality of dividers being integrally formed with one of said first ring and said second ring.

15. The annular dashpot damper of claim 9 further comprising end caps at axial ends of said first and second rings.

16. An annular damper assembly for a turbine engine shaft, comprising:
a first ring disposed one of on or formed integrally with an outer bearing race;
a second ring disposed radially outwardly of said first ring;
a plurality of flow dividers spaced circumferentially between said first ring and said second ring;
a plurality of damping cavities defined between said first ring and said second ring by said plurality of flow dividers;
said damping cavities having a damping fluid therein;
wherein pressure gradients created between flow dividers damp orbital movement of said first ring relative to said second ring independently of a gap between said first ring and said second ring.

17. The annular damper assembly of claim 16, wherein said flow dividers further comprise a blade.

18. The annular damper assembly of claim 16 wherein said damping fluid passes around said blade.

19. The annular damper assembly of claim 16, said second ring further comprising a plurality of orifices wherein said damping fluid passes through said orifices.

20. The annular damper assembly of claim 16 further comprises orifices passing through said flow dividers.
